(19) United States
(12) Patent Application Publication
(10) Pub. No.: US 2013/0319951 A1
(43) Pub. Date: Dec. 5, 2013

(54) Calcium and Aluminum Chlorides for Sulfate Removal from Water

(71) Applicants: Kevin Smith, Houston, TX (US); Jeffrey Snider, Prosper, TX (US); Jimmy Poindexter, Spring, TX (US)

(72) Inventors: Kevin Smith, Houston, TX (US); Jeffrey Snider, Prosper, TX (US); Jimmy Poindexter, Spring, TX (US)

(21) Appl. No.: 13/485,222

(22) Filed: May 31, 2012

(51) Int. Cl. C02F 1/58; C02F 1/68; C02F 1/64

(52) U.S. Cl. 210/722; 210/724

(57) ABSTRACT

Sulfate anions and divalent metal ions in water are removed by treating sulfate-containing water, at a pH of 11-12.5, with aluminum chloride and calcium chloride, optionally together with lime, to form solid ettringite and similar crystalline species. Sulfate is removed as part of the ettringite or ettringite-like materials, but calcium content can be reduced at the same time even though calcium chloride is used as an additive to the treated water. Lime may be used also as a supplemental source of calcium and to help raise the pH. Iron may also be removed by oxidation in a variation of the process. In well treatment, divalent metal ions in flowback fluids can reduce the amount of calcium otherwise necessary to form the solid materials, thus further facilitating recycling of the fluid.

### TECHNICAL FIELD

Sulfate and calcium anions in water are removed by treating the water with calcium chloride and aluminum chloride at a high pH, forming solid calcium aluminum sulfate in the form of ettringite or similar crystalline species which may have one or more substitutions for calcium or aluminum atoms.

### BACKGROUND OF THE INVENTION

Aqueous solutions are used for various types of well treatment in the recovery of hydrocarbons from the earth. Although sulfate is a very weak anion and therefore difficult to remove from water, it can combine with magnesium, barium, strontium and calcium in the earth formations when it is introduced through a well. Heavy metal and alkaline earth metal sulfates can readily plug the formation, frustrating efforts to remove oil or gas. This is particularly vexing in gas shale reservoirs, where the calcium, magnesium, barium and strontium are attached to clays associated with the shale, frequently without a closely associated counterion. Sulfate ions introduced to the formation are almost certain to form insoluble scale; thus even low levels of sulfate in fracturing treatments employing large volumes of water, for example, can result in significant downhole damage. Many naturally occurring and other sources of water used in hydrocarbon recovery operations contain sulfates, which it is desirable to remove before using.

Many downhole formations also harbor sulfate-reducing bacteria, such as Desulfovibrio desulfuricans, Desulfovibrio orientis, and Clostridium nigrificans. Being anaerobic, they metabolize sulfates, creating hydrogen sulfide, which is not only toxic but is notorious for causing corrosion of piping and hydrocarbon recovery equipment. In the past, bacteriocidal treatments have been proposed to combat sulfate-reducing bacteria—see Thompson U.S. Pat. No. 3,089,847, Hoover U.S. Pat. No. 3,562,157 and Dria et al U.S. Pat. No. 4,507,212, for example. Where the water available for well treatment contains sulfates and there are sulfate-reducing bacteria in the formations, which is quite common, removal of the sulfate is indicated to avoid the problems presented by the predictable production of hydrogen sulfide without adding potentially undesirable microbiocidal materials.

We have observed that where water containing sulfate is pumped downhole into a gas shale reservoir, essentially no sulfate will return in the flowback water. As flowback continues, barium and strontium will continue to be seen in the flowback water while the sulfate continues to be absent, indicating that the sulfate is completely consumed by the barium and strontium in the formation; all of the sulfate remains in the form of harmful insoluble barium and strontium formation deposits. Barium and strontium can be expected to be present in the shale gas formations in quantities consistently able to consume virtually any amount of sulfate that might be present in an aqueous well treatment fluid. All of the barium and strontium sulfate thus formed will be deleterious to the operation of the well, and plug the gas flow channels in the rock and proppant pack. A practical way of limiting the amount of sulfate pumped into earth formations is needed.

Relatively high concentrations of sulfate have been removed from water by reverse osmosis and ion exchange, but these methods are not usually practical for the frequently remote locations of hydrocarbon production wells, or for other situations where the water has a relatively low sulfate content, meaning that large volumes of water must be handled to remove a given amount of sulfate. Various methods of precipitation have been used also, including barium chloride treatment, resulting in a completely inert, insoluble barium sulfate precipitate, but the barium chloride is toxic to handle, and expensive. Under commonly encountered conditions of the prior art, some other cations, such as calcium and magnesium, form products generally too soluble, which would result in undesirable quantities of free sulfate remaining in the water. Using calcium to remove sulfate is therefore counterintuitive. Moreover, one should have a good reason to add calcium to fracturing fluid or other well treating fluid, since it can be counterproductive to common scale inhibiting practices, whose objective is to prevent the formation of calcium scale downhole and in the formation.

A practical method of removing sulfate from water, particularly in lower concentrations, in high volumes of water, and particularly in water used in hydrocarbon production, is needed.

### SUMMARY OF THE INVENTION

Our process removes sulfate from water by making the insoluble crystal ettringite and other solids including calcium, aluminum and sulfate. Our process not only removes sulfate from sulfate-containing water, but also, surprisingly, removes calcium even though we add calcium to the water. We utilize a combination of calcium chloride and aluminum chloride, which may be in the form of polyaluminumhydroxychloride [hereafter sometimes “PAHC” or “PAC”], in water. To make ettringite, a molar ratio of calcium to aluminum of 3:1 is necessary, as will be seen from the formula of ettringite below. The calcium and aluminum chlorides may be added to the sulfate-containing water separately or in a prepared mixture, either dry or as a solution. The solids that are formed, including calcium, aluminum and sulfate, will contain at least some ettringite and/or ettringite-like materials.

In one version of our process, the calcium and aluminum from the calcium and aluminum chlorides combine, together with calcium already present in the treated water, with sulfate anions in the treated water to form ettringite, which is removed by settling, filtration, or any other suitable method of removing solids from a solution. Ettringite has the formula

(CaO)₆(Al₂O₃)(SO₄)₃.32H₂O

Ettringite is sometimes expressed as (CaO)₃(Al₂O₃)(CaSO₄)₃.32H₂O. See, for example, Ramsay U.S. Pat. No. 6,280,630, using 3CaO.Al₂O₃.3CaSO₄.31/32H₂O.

In U.S. Pat. Nos. 5,547,588 and 7,326,400 ettringite is represented as Ca₆Al₂(SO₄)₃(OH)₁₂.26H₂O. In the '400 patent, ettringite is formed as part of a process for controlling sulfate in quicklime. It is seen that in all the various notations, the atomic ratio of calcium, aluminum and sulfur is 6:2:3. Various workers have created ettringite in the laboratory, see for example, Baudouin U.S. Pat. No. 4,002,484, beginning at line 15 of column 3:
An ettringite-formation reaction in stoichiometric proportions designates one of the following reactions: the products reacted are introduced in proportions, such as are given hereinbelow, which are the stoichiometric proportions of the reaction. According to the reaction it is desirable not to deviate by more than 20% in either direction from the stoichiometric proportions corresponding to the formation reaction according to the Invention, depending on the mixture of calcic aluminates.

Reaction (1)
CaO,Al₂O₃+2(CaO,H₂O)+3(CaSO₄,2H₂O)+24H₂O→(CaO)₃Al₂O₃, 3CaSO₄, 32H₂O, (which will be designated as “ettringite”), or a mixture of 158 parts by weight (pw) monocalcic aluminate, 148 pw hydrated lime, 516 pw gypsum and 432 pw water, providing 1254 parts by weight of ettringite.

Reaction (2)
(CaO)₃Al₂O₃+3(CaSO₄,2H₂O)+26H₂O→1 ettringite; that is to say a mixture of 270 p.w. tricalcic aluminate, 516 pw gypsum and 468 pw water, giving 1254 pw ettringite.

Reaction (3)
CaO(Al₂O₃)₂+5(CaO,H₂O)+6(CaSO₄,2H₂O)+47H₂O→2 ettringite; that is to say, a mixture of 260 pw monocalcic dialuminate, 370 pw hydrated lime, 1032 pw gypsum, 846 pw water, providing 2508 pw ettringite.

Reaction (4)
12CaO,7Al₂O₃+9(CaO,H₂O)+6(CaSO₄,2H₂O)+47H₂O→7 ettringite; that is to say, 1386 pw of the aluminate indicated, 666 pw hydrated lime, 3612 p.w. gypsum and 3114 pw water, providing 8778 pw ettringite.

Reaction (5)
CaO,6Al₂O₃+17(CaO,H₂O)+18(CaSO₄,2H₂O)+139H₂O→6 ettringite; that is to say, 668 parts by weight of calcium hexa-aluminate, 1258 parts by weight of calcium hydroxide, 3096 parts by weight of gypsum, 2502 parts by weight of water, providing 7524 parts by weight of ettringite.

It is notable that each of the above five various reported reactions adds a stoichiometrically exact amount of water, but for our purposes, the water is present in abundance, as our objective is to remove the sulfate from a water solution or suspension. It is also notable that the formation of ettringite is a complex process even when using laboratory chemicals. Laboratory grade chemicals are not normally used under field conditions, and the well treatment fluids we deal with are infinitely variable. Ettringite occurs naturally, and is also the name of a family of very similar minerals, typically having one or more substitutions of polyvalent metals in place of an aluminum or calcium atom.

We introduce calcium in the form of the chloride because we believe the chlorides are beneficial to the hydrocarbon-containing formations such as shale. Calcium chloride is readily soluble, while calcium hydroxide is slowly soluble and thus more difficult to control as a source of calcium, since it is less predictable; also the dispersibility and solution rates of lime vary with the source, thereby contributing to the difficulty of planning treatment to remove sulfate. Perhaps more importantly, a theme of our invention is that the added chlorides may replace the sulfate in solution, causing the formation of solid sulfate compounds, especially ettringite and ettringite-like materials. Sodium hydroxide can be used to adjust the pH to the desirable range of 11-12.5. If there is any sulfate left in the fluid after our treatment, it is less likely to form calcium sulfate in the presence of higher chloride. Calcium oxide or hydroxide can also be used to increase the pH; in this case, the potential contribution of the calcium in ettringite formation should be considered. Potassium hydroxide may also be used for pH adjustment.

As the source of aluminum, either aluminum chloride, AlCl₃, or polyaluminum chloride may be used. Sometimes known as polyaluminumhydroxychloride or aluminum chlorohydrate, polyaluminum chloride has the general formula AlₙCl₍₃ₙ₋ₘ₎(OH)ₘ, a paradigm for which is Al₁₂Cl₁₂(OH)₂₄. The cation component may form a Keggin structure having 13 aluminum atoms: [Al₁₃O₄(OH)₂₄(H₂O)₁₂]⁷⁺, or [AlO₄Al₁₂(OH)₂₄(H₂O)₁₂]⁷⁺. We use the terms aluminum chlorohydrate, polyaluminum chloride, and polyaluminumhydroxychloride interchangeably, and may use the shorthand term PAC, which should be understood to mean any of these terms.

The aluminum chloride or PAC, or a combination of the two, is used together with calcium chloride, CaCl₂. Formation of ettringite in the treated water will consume calcium and aluminum components in an atomic ratio of 3Ca:1Al. To remove all the sulfate present, the overall ratio should be in a range which will provide 6Ca:2Al:3S, where S represents all the sulfur present as sulfate in the water. To drive the removal of sulfate, the molar ratio of calcium to sulfate should be at least 2:1, preferably higher than 2:1. Various combinations of calcium chloride and aluminum chloride in an atomic ratio of calcium to aluminum of 1:1 to 6:1 may form solids containing calcium, aluminum and sulfate. Some of the calcium aluminum sulfate solids may not be ettringite, and all the sulfate may not be removed if there is not enough calcium and aluminum present, but generally the solids will be readily separated by settling, flocculation, filtration and the like along with the ettringite and ettringite-like materials. While the Ca:Al atomic ratio may be below 3:1 to obtain at least some ettringite or ettringite-like material, we prefer that it should be in the range of 3:1 to 6:1. As may be seen from the data below, it is also desirable to provide an excess of both calcium and aluminum with respect to sulfate. Also, apparently because of the 3:1 atomic ratio of calcium to aluminum in ettringite, it is a surprising aspect of our invention that significant amounts of calcium can be removed along with sulfate in spite of using calcium as a large portion of our additives.

Flowback fluid, and sometimes the makeup water, may contain alkaline earth metal ions other than calcium. By alkaline earth metal ions other than calcium, we mean divalent magnesium, barium, and strontium, all of which are commonly present to at least some extent in underground formations. Thus we may form not only ettringite, but ettringite-like materials having the formula Ca₆₋ₓMₓAl₂(SO₄)₃(OH)₁₂.26H₂O where M is one or more alkaline earth metals other than calcium and x is 0 to 4, it being understood that x need not be an integer because the product of our method may be a mixture.

Generally, our invention aims at removing sulfate from makeup water used in drilling, fracturing, and other well treatments. By makeup water, we mean water which has not yet been introduced into a well but is intended for such use. But the invention also recognizes that flowback water—aqueous fluid recovered from a well after use as a well treatment fluid—will normally contain alkaline earth metals such as calcium, magnesium, barium, and strontium. To the extent that these divalent metal ions can be utilized instead of adding calcium, our invention contemplates the incorporation of them into the ettringite (and ettringite-like materials) we make, where they may substitute for up to four calcium atoms otherwise taken from the makeup water and/or our additives. The flowback water is therefore mixed with makeup water so the flowback water is recycled, a very desirable benefit in itself, as it reduces the quantity of water used in the well treatment fluid. The concentration of calcium, and, usefully, other divalent metals in the flowback fluid, is beneficially measured periodically and factored into the calculations for aluminum chloride or PAC addition (or a combination thereof), to maintain at least the minimum ratio of calcium and other divalent metals to aluminum for generating ettringite or ettringite-like materials.

A typical fracturing or drilling procedure will expect as little as 15% or as much as 70% of the fluid pumped into a well to be recovered as flowback. The rest either physically coats the underground shale or other formation, or enters into a hydration or other chemical relationship with the underground formation material. Assuming, for example that 50% of the fluid pumped is recovered as flowback, a more or less continuous operation will pump a mixture of 50% flowback and 50% makeup fluid. In this case, the operator must provide a makeup stream of at least 50% of the fluid pumped—that is, equal in amount to the flowback. Fracturing, drilling, and other well operations conducted on land almost always rely on fresh water for the makeup, as that is what is available. However, in many areas supporting drilling into shale formations, acid mine drainage is abundant. Acid mine drainage has not been used to any significant extent in fracturing fluids because of its high sulfur and iron contents. Our invention makes it possible to use acid mine drainage (“AMD”) in fracturing and other well treatment fluids. While our process increases the chloride content of the AMD-based fluid, chlorides are friendly to shale formations and widely used in the industry, while we remove the undesirable sulfate from the AMD. Our process may be applied to AMD after the iron is removed by introduction of an oxidizing agent to convert the iron to a higher valance state, causing precipitation of iron oxide.

A liquid form of our reagent may be made by mixing calcium chloride and aluminum chloride in water. The total concentration with respect to water is not critical, as the reagent will very likely be diluted when added to the makeup water or the mixed makeup/flowback fluid. Although we prefer a ratio of the two components of at least 3Ca:1Al, any ratio within the range of 1:1 to 6:1 will contain a certain quantity in the desired ratio of 3:1 for combination with sulfate anion to form ettringite. Desirably, where the objective is removal of all the sulfate, the aluminum will be present in an atomic ratio to sulfur of at least 0.67 to 1. An excess of either aluminum or calcium is not detrimental either to the process of making the reagent or its use, and generally an excess of calcium with respect to aluminum may be beneficial. For the sake of economy, however, where there is a high calcium content in the water and a relatively low sulfate content (which must nevertheless be removed), a lower amount of calcium chloride may be used than otherwise. Calcium sulfate is less soluble in water than sodium sulfate; therefore it might be economical to make both calcium sulfate and ettringite (and/or ettringite-like materials) at the same time. Even a very small amount of combined chlorides in the reagent slurry will be effective to a commensurate degree—that is, effective to form at least some ettringite or ettringite-like, material in water containing at least some sulfate. When our reagent solution is added to the sulfate-containing water, solid ettringite is formed and may be removed easily. Although the desired solids will be formed without agitation, ten seconds or more of agitation will assure dispersion of the additives and enhance solids formation, particularly of the desired ettringite and ettringite-like materials. Small crystals can be flocculated and separated in a clarifier. In addition, calcium, magnesium, and other alkaline earth metals may be removed from flowback water as part of an ettringite-like material, yielding a treated water having a much reduced alkaline earth metal content as well as a much reduced sulfate content.

Alternatively, a dry mixture of calcium chloride and aluminum chloride may be made and dissolved at the site of use. If this is done, all of the above guidelines about ratios and concentrations are applicable. But this method has the advantage that the ratio of ingredients can more readily be adjusted at the work site depending on the current concentration of calcium and sulfate in the fluid to be treated, including not only the composition of the makeup water but also the composition of the flowback water to be mixed with it.

### DETAILED DESCRIPTION OF THE INVENTION

The removal of sulfate according to our invention was demonstrated in the laboratory in a series of tests. Sodium sulfate was added to fresh water to make a test solution containing 2350 parts per million of sulfate (SO₄), described below as “sulfate water.” Various additives were mixed into separate portions of the sulfate water solution, or “West TX A water” as indicated, resulting in solids formation in each case. After each treatment, the SO₄ content of the solution was reported. In the tests reported below in Table A, “lime” is calcium hydroxide in powder form, and “8119” is a mixture of calcium chloride and aluminum chloride in a ratio of 81:19 by weight to provide 11.7% calcium and 1.1% aluminum, corresponding to an atomic ratio of calcium to aluminum of 7.2:1. “6436” is a mixture of calcium chloride and aluminum chloride in a ratio of 64:36 by weight to provide 9.2% calcium and 2.1% aluminum, corresponding to an atomic ratio of calcium to aluminum of 3:1. Molar ratios of calcium to aluminum to sulfate are reported to relate the Ca and Al in the additives to a constant of 1 for the sulfate, which was present in the test water. That is, 1 mole of sulfate will combine with 2 calcium and 0.67 aluminum atoms to make insoluble ettringite. As may be seen in Table A, large portions of the sulfate were removed in all cases; in some, it was entirely removed.

TABLE A

| | | | wt % | |
|---|---|---|---|---|
| Test 1 Mixture: | | | | |
| Sulfate Water | | | 97.7 | |
| Lime (powder) | | | 1.0 | |
| AlCl3 Solution (28.2% AlCl3) | | | 1.3 | |
| mole ratio Ca:Al:sulfate:OH | | 5.51:1.12:1.00:11.05 | | |
| Test 1 Result | “Lime” | | | 420 ppm as SO4 |
| Test 2 Mixture: | | | | |
| Sulfate Water | | | 96.7 | |
| Lime (powder) | | | 2.0 | |
| AlCl3 Solution (28.2% AlCl3) | | | 1.3 | |
| mole ratio Ca:Al:sulfate:OH | | 11.03:1.12:1.00:22.11 | | |
| Test 2 Result | “Lime” | | | 70 ppm as SO4 |
| Test 3 Mixture | | | | |
| Sulfate Water | | | 94.9 | |
| AlCl3 Solution (28.2% AlCl3) | | | 0.76 | |
| NaOH Solution (50% NaOH) | | | 1.0 | |
| CaCl2 Solution (40% CaCl2) | | | 3.3 | |
| mole ratio Ca:Al:sulfate:OH | | 4.85:0.66:1.00:5.09 | | |
| Test 3 Result | CaCl2/caustic | | | 300 ppm as SO4 |

Note: Half of the NaOH solution was added before the CaC12 solution. After
theCaCl2 solution was added, pH was 10.4; adding the other half of the NaOH
yielded a pH of 11.5.

| Test 4 Mixture: | | | | |
|---|---|---|---|---|
| Sulfate Water | | | 94.9 | |
| 8119 Mix | | | 4.1 | |
| NaOH Solution (50% NaOH) | | | 1.0 | |
| mole ratio Ca:Al:sulfate:OH | | 4.84:0.67:1.00:5.09 | | |
| Test 4 Result | CaCl2/Caustic | | | 410 ppm as SO4 |

Notes: The calcium chloride and aluminum chloride solutions were mixed in at 81:19
ratio (by weight) into a single solution: “8119 Mix”. After addition of the NaOH, the
pH was 11.5.

| Test 5 Mixture: | | | | |
|---|---|---|---|---|
| Sulfate Water | | | 92.3 | |
| 8119 Mix | | | 6.2 | |
| NaOH Solution (50% NaOH) | | | 1.5 | |
| mole ratio Ca:Al:sulfate:OH | | 7.39:1.02:1.00:7.64 | | |
| Test 5 Result | CaCl2/Caustic | | | 0 ppm as SO4 |

Notes: increased the 8119 Mix by 50% to drive the sulfate reaction.

| Test 6 Mixture: | | | | |
|---|---|---|---|---|
| Sulfate Water | | | 93.8 | |
| 8119 Mix | | | 5.0 | |
| NaOH Solution (50% NaOH) | | | 1.2 | |
| mole ratio Ca:Al:sulfate:OH | | 5.96:0.82:1.00:6.11 | | |
| Test 6 Result | CaCl2/Caustic | | | 370 ppm as SO4 |

Notes: Reduced the 8119 Mix to 25% more than test 4 to optimize its usage.

| Test 7 Mixture: | | | | |
|---|---|---|---|---|
| Sulfate Water | | | 94.0 | |
| 8119 Mix | | | 4.0 | |
| Lime (powder) | | | 2.0 | |
| mole ratio Ca:Al:sulfate:OH | | 15.79:0.66:1.00:22.11 | | |
| Test 7 Result | CaCl2/Lime | | | 370 ppm as SO4 |

Notes: Used Nelson lime for added source of calcium, hydroxyl, and, potentially,
seeding.

| Test 8 Mixture: | | | | |
|---|---|---|---|---|
| Sulfate Water | | | 95.2 | |
| 6436 Mix | | | 3.2 | |
| NaOH Solution (50% NaOH) | | | 1.6 | |
| mole ratio Ca:Al:sulfate:OH | | 3.01:0.99:1.00:8.15 | | |
| Test 8 Result | CaCl2/Caustic | | | 200 ppm as SO4 |

Notes: 6436 is a solution of CaCl2 and AlCl3 in a 64:36 ratio by weight.

| Test 9 Mixture: | | | | |
|---|---|---|---|---|
| Sulfate Water | | | 95.6 | |
| 6436 Mix | | | 3.2 | |
| Lime | | | 1.2 | |
| mole ratio Ca:Al:sulfate:OH | | 9.41:0.99:1.00:12.82 | | |
| Test 9 Result | CaCl2/Lime | | | 620 ppm as SO4 |
| Test 10 Mixture: | | | | |
| Sulfate Water | | | 94.8 | |
| 6436 Mix | | | 4.0 | |
| Lime | | | 1.2 | |
| mole ratio Ca:Al:sulfate:OH | | 10.16:1.24:1.00:12.82 | | |
| Test 10 Result | CaCl2/Lime | | | 330 ppm as SO4 |
| Test 11 Mixture: | | | | |
| Sulfate Water | | | 93.7 | |
| 6436 Mix | | | 5.0 | |
| Lime | | | 1.30 | |
| mole ratio Ca:Al:sulfate:OH | | 11.88:1.55:1.00:14.37 | | |
| Test 11 Result | CaCl2/Lime | | | 0 ppm as SO4 |
| Test 12 Mixture: | | | | |
| Sulfate Water | | | 93.7 | |
| Lime | | | 1.35 | |
| 6436 Mix | | | 5.0 | |
| mole ratio Ca:Al:sulfate:OH | | 12.15:1.55:1.00:14.92 | | |
| Test 12 Result | CaCl2/Lime | | | 0 ppm as SO4 |
| Test 13 Mixture: | | | | |
| Sulfate Water | | | 92.6 | |
| NaOH Solution (50% NaOH) | | | 2.4 | |
| 6436 Mix | | | 5.0 | |
| mole ratio Ca:Al:sulfate:OH | | 4.71:1.55:1.00:12.23 | | |
| Test 13 Result | CaCl2/Caustic | | | 480 ppm as SO4 |
| Test 14 Mixture: | | | | |
| West TX A Water | | | 93.7 | |
| Lime | | | 1.35 | |
| 6436 Mix | | | 5.0 | |
| mole ratio Ca:Al:sulfate:OH | | 12.15:1.55:1.00:14.92 | | |
| Test 14 Result | CaCl2/Lime | | | 260 ppm as SO4 |

Notes: West TX A water was tested and found to contain 1543.22 ppm of sulfate.

| Test 15 Mixture: | | | | |
|---|---|---|---|---|
| West TX A Water | | | 93.5 | |
| Lime | | | 1.50 | |
| 6436 Mix | | | 5.0 | |
| mole ratio Ca:Al:sulfate:OH | | 12.98:1.55:1.00:16.58 | | |
| Test 15 Result | CaCl2/Lime | | | 1 ppm as 504 |
| Test 16 Mixture: | | | | |
| Conoco Water | | | 92.3 | |
| 8119 Mix | | | 6.2 | |
| NaOH Solution (50% NaOH) | | | 1.5 | |
| mole ratio Ca:Al:sulfate:OH | | 7.39:1.02:1.00:7.64 | | |
| Test 16 Result | CaCl2/Caustic | | | 420 ppm as SO4 |

Notes: Test 5 repeated using West TX A water (pH 12.1)

| Test 17 Mixture: | | | | |
|---|---|---|---|---|
| Sulfate Water | | | 92.2 | |
| 8119 Mix | | | 6.2 | |
| NaOH Solution (50% NaOH) | | | 1.6 | |
| mole ratio Ca:Al:sulfate:OH | | 7.39: 1.02: 1.00:8.15 | | |
| Test 17 Result | CaCl2/Caustic | | | 490 ppm as SO4 |

Notes: Test 5 repeat (pH 12.1)

| Test 18 Mixture: | | | | |
|---|---|---|---|---|
| West TX A Water | | | 91.8 | |
| 8119 Mix | | | 6.6 | |
| NaOH Solution (50% NaOH) | | | 1.6 | |
| mole ratio Ca:Al:sulfate:OH | | 7.86:1.08:1.00:8.15 | | |
| Test 18 Result | CaCl2/Caustic | | | 440 ppm as SO4 |

Notes: pH 12.1

| Test 19 Mixture: | | | | |
|---|---|---|---|---|
| West TX A Water | | | 92.2 | |
| 8119 (Substitute PAC for AC) | | | 6.2 | |
| NaOH Solution (50% NaOH) | | | 1.6 | |
| mole ratio Ca:Al:sulfate:OH | | 7.39:1.02:1.00:8.15 | | |
| Test 19 Result | CaCl2/Caustic | | | 630 ppm as SO4 |
| Notes: pH 12.1 | | | | |
| Test 20 Mixture: | | | | |
| West TX A Water | | | 97.7 | |
| Lime (powder) | | | 1.0 | |
| AlCl3 Solution (28.2% AlCl3) | | | 1.3 | |
| mole ratio Ca:Al:sulfate:OH | | 5.51:1.12:1.00:11.05 | | |
| Test 20 Result | Lime | | | 170 ppm as SO4 |

Notes: Repeat of test 1 using West TX A water.

| Test 21 Mixture: | | | | |
|---|---|---|---|---|
| West TX A Water | | | 95.8 | |
| Lime Slurry 35% | | | 2.9 | |
| AlCl3 Solution (28.2% AlCl3) | | | 1.3 | |
| mole ratio Ca:Al:sulfate:OH | | 5.52:1.12:1.00:11.06 | | |
| Test 21 Result | Lime | | | 440 ppm as SO4 |

Notes: Repeat of test 1 using West TX A water and using Lime Slurry in place of
powder

| Test 22 Mixture: | | | | |
|---|---|---|---|---|
| West TX A Water | | | 92.9 | |
| Lime Slurry 35% | | | 5.8 | |
| AlCl3 Solution (28.2% AlCl3) | | | 1.3 | |
| mole ratio Ca:Al:sulfate:OH | | 11.20:1.12:1.00:22.44 | | |
| Test 22 Result | Lime | | | 320 ppm as SO4 |

Notes: 2× lime slurry

| Test 23 Mixture: | | | | |
|---|---|---|---|---|
| West TX A Water | | | 90.7 | |
| Lime Slurry 35% | | | 8.0 | |
| AlCl3 Solution (28.2% AlCl3) | | | 1.3 | |
| mole ratio Ca:Al:sulfate:OH | | 15.44:1.12:1.00:30.95 | | |
| Test 23 Result | Lime | | | 490 ppm as SO4 |

Notes: Lime slurry very high.

| Test 24 Mixture: | | | | |
|---|---|---|---|---|
| West TX A Water | | | 95.6 | |
| Lime Slurry 35% | | | 2.9 | |
| AlCl3 Solution (28.2% AlCl3) | | | 1.5 | |
| mole ratio Ca:Al:sulfate:OH | | 5.52:1.29:1.00:11.06 | | |
| Test 24 Result | Lime | | | 270 ppm as SO4 |

Notes: Increase Al slightly from test 21.

| Test 25 Mixture: | | | | |
|---|---|---|---|---|
| West TX A Water | | | 95.4 | |
| Lime Slurry 35% | | | 2.9 | |
| AlCl3 Solution (28.2% AlCl3) | | | 1.7 | |
| mole ratio Ca:Al:sulfate:OH | | 5.52:1.47:1.00:11.06 | | |
| Test 25 Result | Lime | | | 210 ppm as SO4 |

Notes: Increase Al slightly from test 24.

| Test 26 Mixture: | | | | |
|---|---|---|---|---|
| West TX A Water | | | 92.5 | |
| Lime Slurry 35% | | | 5.8 | |
| AlCl3 Solution (28.2% AlCl3) | | | 1.7 | |
| mole ratio Ca:Al:sulfate:OH | | 11.20:1.47:1.00:22.44 | | |
| Test 26 Result | Lime | | | 250 ppm as SO4 |

Notes: Doubled lime from test 25.

| Test 27 Mixture: | | | | |
|---|---|---|---|---|
| West TX A Water | | | 95.1 | |
| Lime Slurry 35% | | | 2.9 | |
| AlCl3 Solution (28.2% AlCl3) | | | 2.0 | |
| mole ratio Ca:Al:sulfate:OH | | 5.60:1.72:1.00:11.22 | | |
| Test 27 Result | Lime | | | 220 ppm as SO4 |

Notes: Increased Al slightly from test 25. (pH12.1).

| Test 28 Mixture: | | | | |
|---|---|---|---|---|
| West TX A Water | | | 89.2 | |
| Lime Slurry 35% | | | 5.8 | |
| 6436 Mix | | | 5.0 | |
| male ratio Ca:Al:sulfate:OH | | 15.90:1.55:1.00:22.44 | | |
| Test 28 Result | CaCl2/Lime | | | 420 ppm as SO4 |

Notes: Repeat of test 15 using lime slurry.

| Test 29 Mixture: | | | | |
|---|---|---|---|---|
| West TX A Water | | | 92.1 | |
| Lime Slurry 35% | | | 2.9 | |
| 6436 Mix | | | 5.0 | |
| mole ratio Ca:Al:sulfate:OH | | 10.30:1.55:1.00:11.22 | | |
| Test 29 Result | CaCl2/Lime | | | 90 ppm as SO4 |

Notes: Less lime slurry than test 28.

| Test 30 Mixture: | | | | |
|---|---|---|---|---|
| West TX A Water | | | 93.3 | |
| Lime Slurry 30% | | | 3.3 | |
| AlCl3 Solution (28.2% AlCl3) | | | 3.4 | |
| mole ratio Ca:Al:sulfate:OH | | 5.46:2.93:1.00:10.94 | | |
| Test 30 Result | Lime | | | 570 ppm as SO4 |

Notes: New 30% lime solution. pH about 9.

| Test 31 Mixture: | | | | |
|---|---|---|---|---|
| West TX A Water | | | 95.0 | |
| Lime Slurry 30% | | | 3.3 | |
| AlCl3 Solution (28.2% AlCl3) | | | 1.7 | |
| mole ratio Ca:Al:sulfate:OH | | 5.46:1.47:1.00:10.94 | | |
| Test 31 Result | Lime | | | 180 ppm as SO4 |

Notes: 30% lime solution (pH 11.0)

| Test 32 Mixture: | | | | |
|---|---|---|---|---|
| West TX A Water | | | 95.2 | |
| Lime Slurry 30% | | | 3.3 | |
| AlCl3 Solution (28.2% AlCl3) | | | 1.5 | |
| mole ratio Ca:Al:sulfate:OH | | 5.46:1.29:1.00:10.94 | | |
| Test 32 Result | Lime | | | 130 ppm as SO4 |

Notes: 30% lime solution (pH 11.8)

| Test 33 Mixture: | | | | |
|---|---|---|---|---|
| West TX A Water | | | 95.7 | |
| Lime Slurry 30% | | | 2.8 | |
| AlCl3 Solution (28.2% AlCl3) | | | 1.5 | |
| mole ratio Ca:Al:sulfate:OH | | 4.70:1.29:1.00:9.42 | | |
| Test 33 Result | Lime | | | 520 ppm as SO4 |

Notes: 30% lime solution (pH 10.5)

| Test 34 Mixture: | | | | |
|---|---|---|---|---|
| West TX A Water | | | 94.5 | |
| Lime Slurry 30% | | | 4.0 | |
| AlCl3 Solution (28.2% AlCl3) | | | 1.5 | |
| mole ratio Ca:Al:sulfate:OH | | 6.68:1.29:1.00:13.40 | | |
| Test 34 Result | Lime | | | 320 ppm as SO4 |

Notes: 30% lime solution

| Test 35 Mixture: | | | | |
|---|---|---|---|---|
| West TX A Water | | | 94.7 | |
| Lime Slurry 30% | | | 3.8 | |
| AlCl3 Solution (28.2% AlCl3) | | | 1.5 | |
| mole ratio Ca:Al:sulfate:OH | | 6.22:1.29:1.00:12.47 | | |
| Test 35 Result | Lime | | | 210 ppm as SO4 |
| Notes: 30% lime solution | | | | |
| Test 36 Mixture: | | | | |
| West TX A Water | | | 94.6 | |
| Lime Slurry 30% | | | 3.8 | |
| AlCl3 Solution (28.2% AlCl3) | | | 1.7 | |
| mole ratio Ca:Al:sulfate:OH | | 6.22:1.43:1.00:12.47 | | |
| Test 36 Result | Lime | | | 240 ppm as SO4 |

Notes: 30% lime solution

| Test 37 Mixture: | | | | |
|---|---|---|---|---|
| West TX A Water | | | 95.0 | |
| Lime Slurry 30% | | | 3.0 | |
| AlCl3 Solution (28.2% AlCl3) | | | 2.0 | |
| mole ratio Ca:Al:sulfate:OH | | 4.96:1.69:1.00:9.95 | | |
| Test 37 Result | Lime | | | 140 ppm as SO4 |

Notes: 30% lime solution. pH 10.5

| Test 38 Mixture: | | | | |
|---|---|---|---|---|
| West TX A Water | | | 94.5 | |
| Lime Slurry 30% | | | 3.3 | |
| AlCl3 Solution (28.2% AlCl3) | | | 2.2 | |
| mole ratio Ca:Al:sulfate:OH | | 5.53:1.86:1.00:11.08 | | |
| Test 38 Result | Lime | | | 300 ppm as SO4 |

Notes: 30% lime solution

| Test 39 Mixture: | | | | |
|---|---|---|---|---|
| West TX A Water | | | 94.9 | |
| Lime Slurry 30% | | | 3.4 | |
| AlCl3 Solution (28.2% AlCl3) | | | 1.7 | |
| mole ratio Ca:Al:sulfate:OH | | 5.63:1.43:1.00:11.27 | | |
| Test 39 Result | Lime | | | 310 ppm as SO4 |

Notes: 30% lime solution

| | | | |
|---|---|---|---|
| Test 42 Mixture | | | |
| West TX water B (2700 ppm sulfate) | | 90.5 | |
| AlCl3 Solution (28.2% AlCl3) | | 2.0 | |
| CaCl2 Solution (40% CaCl2) | | 6.0 | |
| NaOH Solution (50% NaOH) | | ≈1.5 | |
| Mole ratio Ca:Al:sulfate:OH | 8.49:1.66:1.00:7.35 | | |
| Test 42 Result | | | 5 ppm as SO4 |
| Test 43 Mixture | | | |
| West TX water B (2700 ppm sulfate) | | 92.8 | |
| AlCl3 Solution (28.2% AlCl3) | | 1.5 | |
| CaCl2 Solution (40% CaCl2) | | 4.5 | |
| NaOH Solution (50% NaOH) | | ≈1.2 | |
| Mole ratio Ca:Al:sulfate:OH | 6.21:1.21:1.00:5.73 | | |
| Test 43 Result | | | 5 ppm as SO4 |
| Test 44 Mixture | | | |
| West TX water B (2700 ppm sulfate) | | 95.0 | |
| AlCl3 Solution (28.2% AlCl3) | | 1.0 | |
| CaCl2 Solution (40% CaCl2) | | 3.0 | |
| NaOH Solution (50% NaOH) | | ≈1.0 | |
| Mole ratio Ca:Al:sulfate:OH | 4.04:0.79:1.00:4.67 | | |
| Test 44 Result | | | 1450 ppm as SO4 |
| Test 45 Mixture | | | |
| West TX water B (2700 ppm sulfate) | | 94.3 | |
| AlCl3 Solution (28.2% AlCl3) | | 1.5 | |
| CaCl2 Solution (40% CaCl2) | | 3.0 | |
| NaOH Solution (50% NaOH) | | ≈1.2 | |
| Mole ratio Cal:Al:sulfate:OH | 4.07:1.66:1.00:5.64 | | |
| Test 45 Result | | | 1400 ppm as SO4 |
| Test 46 Mixture | | | |
| West TX water B (2700 ppm sulfate) | | 94.0 | |
| AlCl3 Solution (28.2% AlCl3) | | 1.0 | |
| CaCl2 Solution (40% CaCl2) | | 4.0 | |
| NaOH Solution (50% NaOH) | | ≈1.0 | |
| Mole ratio Ca:Al:sulfate:OH | 5.45:0.80:1.00:4.72 | | |
| Test 46 Result | | | 450 ppm as SO4 |
| Test 47 Mixture | | | |
| West TX water B (2700 ppm sulfate) | | 93.3 | |
| AlCl3 Solution (28.2% AlCl3) | | 1.5 | |
| CaCl2 Solution (40% CaCl2) | | 4.0 | |
| NaOH Solution (50% NaOH) | | ≈1.2 | |
| Mole ratio Ca:Al:sulfate:OH | 5.49:1.21:1.00:5.70 | | |
| Test 47 Result | | | 0 ppm as SO4 |

The “West TX A water” used in the above tests was obtained from a well drilled into
the West Texas aquifer and analyzed as follows:

| | | |
|---|---|---|
| Sodium | 2642.51 | Parts per million |
| Calcium | 954.53 | Parts per million |
| Magnesium | 342.97 | Parts per million |
| Potassium | 8.48 | Parts per million |
| Strontium | 5.33 | Parts per million |
| Barium | 0.01 | Parts per million |
| Lithium | 0.38 | Milligrams per Liter |
| Iron | 8.39 | Milligrams per Liter |
| Boron | 0.73 | Milligrams per Liter |
| Chlorine | 4821.20 | Parts per million |
| Sulfate | 1543.22 | Parts per million |
| Bicarbonate | 555.1 | Parts per million |
| CO2 dissolved | 18.42 | Milligrams per Liter |
| Density | 0.96 | |
| Ph | 6.68 | |
| Total Dissolved Solids | 960 | Milligrams per Liter |

“West Texas Water B” was obtained similarly, containing sulfate rounded at 2700
ppm sulfate.

### Discussion of the Tests Reported in Table A

Several tests resulted in removal of all the sulfate. All of the tests are consistent with a conclusion that adding calcium chloride and aluminum chloride to a solution containing sulfate within certain ratio ranges and pHs will remove sulfate as solids. The sulfate appears to be taken into the solids in a ratio of 6Ca 2Al:3(SO₄), or 2Ca:0.67Al:1 sulfate, which is the ratio for ettringite formation, and the solids formation is driven by an excess of calcium chloride and aluminum chloride in the solution with respect to sulfate. In particular, we find that a molar ratio of calcium to aluminum of at least 4:1, together with a molar ratio of aluminum to sulfate of at least 1:1, will be very successful at removing sulfate in the form of solids. More particularly, we may use a molar ratio of calcium to aluminum within the range of 5.5:1 to 10:1 while maintaining a molar excess of aluminum to sulfate. Desirably, the molar excess of aluminum to sulfate will be in range of a molar ratio of aluminum to sulfate of 1:1 to 1.2:1, but higher ratios, for example up to 3:1, may be effective while even higher ratios may not be harmful. Although lime can provide the calcium necessary for the formation of calcium-aluminum-sulfate solids, and although lime improved the results when increased with respect to aluminum, as seen in tests 1 and 2, calcium chloride is advantageous because (a) lime may tend to form calcium carbonate scale in the formation and on equipment, (b) other scales such as calcium sulfate scales are less likely to form when using calcium chloride because of the common ion effect, i.e. the presence of additional chloride will favor soluble rather than insoluble combinations, (c) calcium chloride is more soluble and reacts faster than lime, making the overall practice easier in the field, and (d) the solution rate of lime tends to vary with its source and more with the vagaries of the treated fluid than the calcium chloride, rendering the results less predictable. In addition, as seen in the tests using “8119,” the two chlorides are readily blended in desired ratios, meaning they can be dosed together to treat a given sulfate concentration. Nevertheless, up to 50 mole percent of the calcium which would otherwise be supplied in our invention by the addition of calcium chloride may optionally be provided by lime. By “up to” 50 mole %, we do not mean to include zero percent. Since we are speaking of an actual addition of at least some lime, albeit an optional one.

A separate series of tests was run using samples of the same waters, the same reagents, and the same procedures as recited above for fifteen of the Table A tests, but this time also measuring calcium removal. These tests were run under somewhat more stringent laboratory conditions than the tests reported above. Table B reports the calcium, aluminum, sulfate, OH and pH of the water resulting after formation and settling of solids according to our invention as practiced according to the procedures used in the corresponding numbered tests of Table A.

TABLE B

| Sample/Test # | Ca | Al | SO4 | OH | pH |
|---|---|---|---|---|---|
| “West TX A Water” prior to treatment | 954.5 | 0 | 1543 | 0 | 6.68 |
| “Sulfate Water” prior to treatment | 841.6 | 0 | 2377 | 0 | 6.48 |
| 12 (Sulfate water) | 58.41 | 0 | 11.83 | 123.1 | 11.83 |
| 14 (West TX A water) | 80.67 | 0 | 429.2 | 57.1 | 11.74 |
| 15 (West TX A water) | 49.89 | 0 | 27.27 | 231.2 | 11.57 |
| 16 (West TX A water | 37.41 | 0 | 490.2 | 0 | 11.33 |
| 17 (Sulfate water) | 30.11 | 0 | 496.1 | 259.1 | 11.78 |
| 18 West TX A water) | 16.71 | 0 | 455.3 | 0 | 11.50 |
| 21 (West TX A water) | 142.8 | 0.42 | 394.9 | 73.4 | 11.96 |
| 22 (West TX A water) | 54.65 | 0 | 456.5 | 160.5 | 12.03 |
| 23 (West TX A water) | 128.9 | 0 | 359.2 | 242.8 | 12.07 |
| 24 (West TX A water) | 86.95 | 0 | 304.6 | 0 | 11.65 |
| 25 (West TX A water) | 186.8 | 11.72 | 36.72 | 0 | 10.21 |
| 26 (West TX A water) | 90.41 | 0 | 286.9 | 308 | 11.90 |
| 27 (West TX A water) | 108.9 | 0.7 | 190.5 | 250.2 | 11.92 |
| 28 (West TX A water) | 66.69 | 0 | 385.4 | 182.2 | 11.81 |
| 29 (West TX A water) | 27.77 | 13.58 | 0 | 74.8 | 11.39 |

It will be seen that our process not only removes sulfate, but also calcium, both at very significant rates. In the above results, calcium reduction ranges from 77-97% while sulfate is also removed in the range of 68-100%. It is therefore not only useful for treating makeup water containing calcium but especially for mixed well treatment fluids including calcium-containing flowback fluids.

Our invention is applicable to many naturally occurring waters, but is also effective in removing sulfate from treated or partially treated waters, and various waste waters containing sulfate, such as acid mine drainage water. Our invention enables the use of acid mine drainage waters, notorious for their sulfate content among other problems, in well drilling and for other well treatment in hydrocarbon recovery. The acid mine drainage is treated by our invention to remove the sulfate and then can be employed as a well drilling or well treatment fluid with a greatly reduced risk of barium and strontium sulfate blockages in the hydrocarbon-bearing earth formations.

Where the water to be treated contains notable amounts of iron, the operator may wish first to treat it with an oxidizing agent to remove the iron. Iron can be removed in a wide range of pH's, including a broad range well below 9.0 and above 9.0. Frequently the original makeup fluid will have a pH of 6 or 7, for example. Chemical oxidizers—typically hydrogen peroxide or sodium hypochlorite—will oxidize lower valence iron compounds to higher valence iron oxides, which will precipitate. Various electrochemical and other methods can be used to oxidize and remove iron, as is known in the art; we can use any oxidizing or other method for removing iron before our method steps to remove sulfate. Removing iron before using our aluminum chloride-calcium chloride treatment will enhance the value of the resulting solids for use in the cement and concrete industries, for roadbed stabilization, and for other purposes where a noticeable iron content is considered to be undesirable.

It is seen that our invention includes a method of treating water to remove sulfate therefrom comprising (a) providing a pH in said water of 11 to 12.5, (b) adding calcium chloride and aluminum chloride to the water containing sulfate in an atomic ratio of calcium to aluminum of at least 4:1, and in a molar ratio of aluminum to sulfate of at least 1:1, thereby forming solids containing calcium, aluminum and sulfate, and (c) separating the solids from said water.

Our invention also includes a method of removing sulfate and calcium ions from an aqueous well treatment fluid, said well treatment fluid comprising a makeup/flowback water mixture of (i) 30% to 85% by weight makeup water containing at least sulfate ions and (ii) 15% to 70% by weight flowback water containing alkaline earth metal ions including calcium ions, the method comprising (a) providing a pH in the well treatment fluid of 11-12.5, (b) adding to the well treatment fluid aluminum chloride in an amount sufficient to provide in the well treatment fluid a mole ratio of aluminum to sulfate ions of at least 1:1 (c) adding to the well treatment fluid an amount of CaCl₂ sufficient to provide, together with the alkaline earth metal ions in the flowback water, an atomic ratio of alkaline earth metal ions to aluminum of at least 5:1, thereby forming ettringite or a solid ettringite-like material containing sulfate in the well treatment fluid, and (d) removing the ettringite or ettringite-like material containing calcium and sulfate from the well treatment fluid.

And, our invention includes a method of treating water containing sulfate ions, calcium ions and optionally one or more alkaline earth metal ions other than calcium, the water having a pH lower than 11.0, to remove both calcium ions and sulfate ions therefrom comprising (a) adjusting the pH in the water to 11-12.5, (b) adding calcium chloride and aluminum chloride to the water in an atomic ratio of calcium to aluminum of 4:1 to 10:1, in amounts effective to form ettringite or an ettringite-like material of the formula Ca₆₋ₓMₓAl₂(SO₄)₃(OH)₁₂.26H₂O where M is one or more alkaline earth metals other than calcium and x is a number from 0 to 4, and (c) separating the solids from the water.

Treatment with calcium and aluminum chlorides may in any case be preceded by removing iron which might be present, by adding an oxidizing agent and removing the iron oxides produced thereby.

1. Method of treating water containing sulfate to remove sulfate therefrom comprising (a) providing a pH in said water of 11 to 12.5, (b) adding calcium chloride and aluminum chloride to said water containing sulfate in an atomic ratio of calcium to aluminum of at least 4:1, and in a molar ratio of aluminum to sulfate of at least 1:1, thereby forming solids containing calcium, aluminum and sulfate, and (c) separating said solids from said water.

2. Method of claim 1 including enhancing formation of said solids by agitating said water containing in step (b) for at least ten seconds.

3. Method of claim 1 wherein said calcium chloride and said aluminum chloride are added to said water containing sulfate in step (a) in the form of a premixed solution.

4. Method of claim 1 wherein said calcium chloride and said aluminum chloride are added to said water containing sulfate in step (a) in the form of a dry mixture.

5. Method of claim 1 wherein said calcium chloride and aluminum chloride are added in an amount to provide an atomic ratio of calcium to aluminum in said water containing sulfate of 5.5:1 to 10:1.

6. Method of claim 1 wherein said aluminum chloride is added to said water containing sulfate in an amount to provide a stoichiometric ratio of aluminum to sulfate of 1:1 to 1.2:1.

7. Method of claim 1 wherein lime is added in place of calcium chloride to provide up to half of the calcium added to said water containing sulfate.

8. Method of removing sulfate and calcium ions from an aqueous well treatment fluid, said well treatment fluid comprising a makeup/flowback water mixture of (i) 30% to 85% by weight makeup water containing at least sulfate ions and (ii) 15% to 70% by weight flowback water containing alkaline earth metal ions including calcium ions, said method comprising
(a) providing a pH in said well treatment fluid of 11-12.5, (b) adding to said well treatment fluid aluminum chloride in an amount sufficient to provide in said well treatment fluid a mole ratio of aluminum to sulfate ions of at least 1:1 (c) adding to said well treatment fluid an amount of CaCl₂ sufficient to provide, together with said alkaline earth metal ions in said flowback water, an atomic ratio of alkaline earth metal ions to aluminum of at least 5:1, thereby forming ettringite or a solid ettringite-like material of the formula Ca₆₋ₓMₓAl₂(SO₄)₃(OH)₁₂.26H₂O where M is one or more alkaline earth metals other than calcium and x is a number from 0 to 4 in said well treatment fluid, and (d) removing said ettringite or ettringite-like material from said well treatment fluid.

9. Method of claim 8 wherein said alkaline earth metal ions in said flowback water comprise divalent calcium, magnesium, strontium, or barium ions or a combination thereof.

10. (canceled)

11. Method of claim 8 including mixing said aluminum chloride and said calcium chloride in water and adding them to said well treatment fluid together as a solution.

12. Method of claim 8 including agitating said well treatment fluid after addition of said aluminum chloride and calcium chloride for at least ten seconds to promote formation of said ettringite or ettringite-like material.

13. Method of claim 8 wherein, in step (a) said pH of said well treatment fluid is provided by adding to said well treatment fluid an amount of sodium hydroxide, potassium hydroxide, lime, or a mixture thereof to effect a pH of 11.0 to 12.5 in said well treatment fluid.

14. Method of claim 8 wherein said ettringite or ettringite-like material is removed from said well treatment fluid by filtering, settling, or flocculation and clarification.

15. Method of treating water containing sulfate ions, calcium ions and optionally one or more alkaline earth metal ions other than calcium, said water having a pH lower than 11.0, to remove both calcium ions and sulfate ions therefrom comprising (a) adjusting the pH in said water to 11-12.5, (b) adding calcium chloride and aluminum chloride to said water in an atomic ratio of calcium to aluminum of 4:1 to 10:1, in amounts effective to form ettringite or an ettringite-like material of the formula Ca₆₋ₓMₓAl₂(SO₄)₃(OH)₁₂.26H₂O where M is one or more alkaline earth metals other than calcium and x is a number from 0 to 4, and (c) separating said solids from said water.

16. Method of claim 15 including, in step (c), separating at least some of said ettringite or ettringite-like material from said water by filtration, centrifugation, flocculating, clarifying, settling, or any other suitable solid separation technique.

17. Method of claim 15 wherein said water comprises acid mine drainage or a well treatment fluid.

18. Method of claim 15 wherein the amount of calcium in said ettringite or ettringite-like material exceeds the amount of calcium originally present in said water.

19. Method of claim 15 wherein said water also contains iron, including the step, prior to step (a), adding in oxidizing agent to said water in an amount effective to elevate the oxidation state of said iron and form insoluble iron oxide.

20. Method of claim 19 including removing at least some of said insoluble iron oxide from said water prior to step (b).
